(19) United States
(12) Patent Application Publication
(10) Pub. No.: US 2002/0006103 A1
(43) Pub. Date: Jan. 17, 2002

(54) STORAGE CARD

(76) Inventor: DAN DUROJ, BANDHAGEN (SE)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 09/282,792

(22) Filed: Nov. 8, 1999

(30) Foreign Application Priority Data
Jan. 7, 1999 (SE) 9900016-8

(51) Int. Cl. G11B 3/70; G11B 5/84; G11B 7/26

(52) U.S. Cl. 369/273; 369/290

(57) ABSTRACT

There is a desire to improve the different types of card that carry information. If the technology is going to be of interest for the user, the use of the card must be as problem-free as it is possible to achieve. The card must be adapted to fit writing and reading devices and provide a place for storing different kinds of information. One objective of the present invention is to realize this desire.

The invention comprises a storage card (1), for use together with a CD, DVD or similar device, with a rectangular shape that includes a circular segment (4) for storing information. The card has four right-angled corners (2) that are rounded and the rounding is equivalent to the circumference of the outer edge of a mini-CD.

The present invention relates to a storage card, for use together with a CD, DVD or similar device, with a rectangular shape that includes a circular segment for storing information.

It has long been possible to collect and store information in the form of sound, images and text on circular discs known as CDs (Compact Discs). The information is written in and stored on a processed layer of material within the disc and then becomes available by the CD being placed in a reading unit, a CD-reader. The CD-reader reads the information and is in turn connected to a loudspeaker system, a computer screen or other type of playback arrangement.

There is also another type of disc called a DVD (Digital Versatile Disc) that is primarily divided according to two main functions, DVD-Video and DVD-ROM (Read Only Memory). DVD-Video stores video programmes and plays them back via a DVD player connected to a TV. DVD-ROM stores information of the type normally stored in computers. The stored information is made available by a DVD-player being connected to a computer. DVDs characterised by being able to read in information several times can also be found. In addition, DVD can be found in what is known as an audio format. DVDs can store information in several layers and can be said to constitute a larger and faster type of CD.

The main advantage of CD and DVD technologies is that the writing and reading of information is essentially free of disturbing interruptions and that the discs are relatively insensitive to being affected mechanically on the surface as the information is stored within the disc.

In the following text, the word CD is used throughout. It is assumed that it is clearly understood that this can also apply to DVD or other similar digital storage units.

Recently, CD business cards have been designed that are rectangular like an ordinary business card and that utilise the information storage technology of the CD. These are quite simply produced by a CD being cut to a rectangular appearance. A circular CD-functioning area remains on the card. The card is placed in an ordinary CD player for reading. The German utility model DE, U1, 29616619 and DE, U1, 29709648 show examples of such business cards. The size of the card is equivalent to that of an ordinary business card. The cards that are found in the marketplace today do not function in a problem-free manner regarding the contact with the writing and reading devices or the possibilities for storing information.

There are also other cards with different functions. There are cards for withdrawing money, registering a purchase, clocking in or out, membership cards, telephone cards and an endless number of others. An ordinary person carries on them an almost unmanageable number of cards to gain access to the different functions that are now part of their day-to-day life.

Naturally, there is a desire to improve the different types of cards that carry information. If the technology is going to be of interest for the user, the use of the card must be as problem-free as it is possible to achieve. The card must be adapted to fit writing and reading devices and provide a place for storing different kinds of information. One objective of the present invention is to realise this desire.

The objective is achieved with a storage card that has the features and characteristics given in the claims. Other features and advantages are evident from the following description of an example of an embodiment with reference to the enclosed drawings, of which

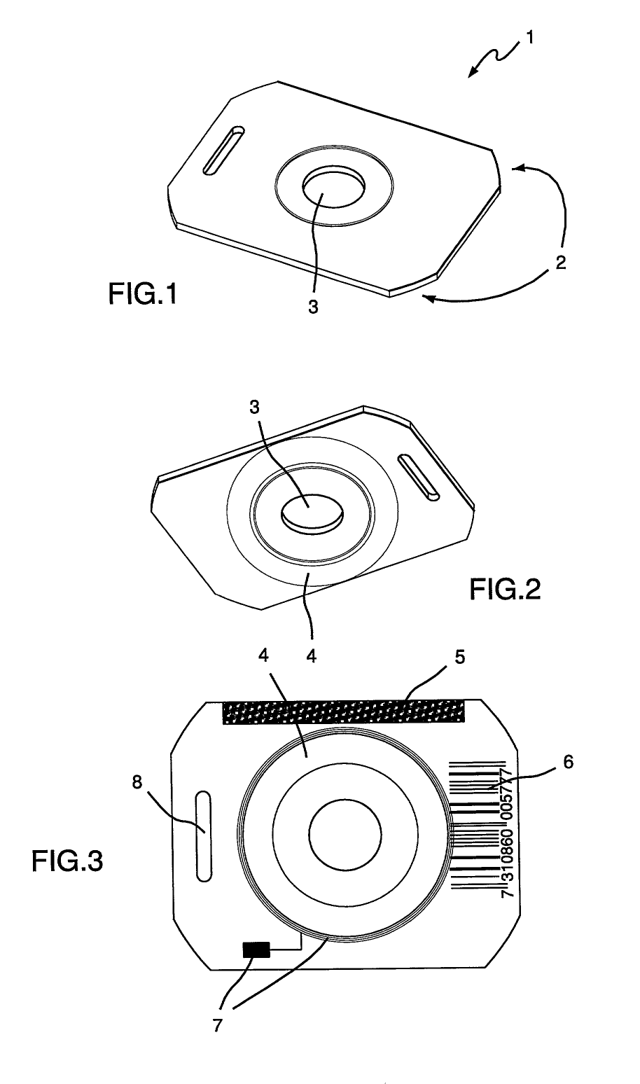

FIG. 1 and FIG. 2 show a card with the preferred design and

FIG. 3 shows a card with the information storage units.

Storage card 1 is rectangular and has rounded corners 2 that are equivalent to the outer diameter of a mini-CD. The card 1 can have a centrally located circular opening 3 for receiving the holding device of a CD-reader unit (not shown in the figure). The card 1 is provided with a circular partial segment 4 onto which information is read, stored and fetched with the help of CD technology. The card 1 can also be provided with a magnetic field 5, bar codes 6 and/or transponders 7 for equivalent handling of information using technology intended for the purpose.

The card 1 is manufactured from the material used in the manufacture of a normal CD. The shape of the card 1 is governed both by the amount of information that is to be stored and by the appearance and shape of the reading devices, both CD-readers and other card readers, that are found in the marketplace today. Primarily, card 1 has a shape that can be placed in a mini-CD-reader. The basic shape is a rectangle where the corners 2 are rounded so that the diagonal of the card is equivalent to the diameter of a mini-CD. The curved shape of the four corners is equivalent to the outer edge of a mini-CD, which has a diameter of 80 mm. The corners 2 of the card function as contact surfaces and centre the card in the CD-reader. The advantage of rounding just the corners and not the whole of the side of the card is that the card retains four straight edges. Straight edges increase the possibility of providing the card with further information.

The card has a preferred length of 72 mm and a preferred width of 56 mm. The width is governed by the width of the most common cards found in the marketplace. The outer card dimensions of 72×56 mm allow room for a circular partial segment 4 with a maximum diameter of 54 mm at the centre for the information that is to be controlled with the help of CD technology. To make it possible to be able to access the stored information with the help of a standard CD-reader, card 1 can be placed in an adapter unit that is in turn shaped so that it can be placed in the standard disc tray part of a CD-reader or constitute an automated adjustable part of the reader.

The previously known CD-business card has utilised CD-ROM (Compact Disc-Read Only Memory) technology that refers to a disc where information is written in once and thereafter is only readable, i.e. new information cannot be written in. It is normally this type of reproduction of information that is of interest for a business card.

For the present storage card 1, it is advantageous to use CD-R (Compact Disc-Recordable) technology, which refers to a disc on which one can continuously write in new information. CD-Rs have a somewhat more sensitive surface but this can be corrected easily with an extra layer of protective material. CD-WO (Compact Disc-Write Once) is also a similar disc.

Other CDs with other functions can naturally be used. Discs that can be considered are, for example; CD-ROM XA (Compact Disc-Read Only Memory Extended Architecture), which is a CD-ROM designed to have better audio and video functions so that it is more suitable for multi-media applications, CD-DA (Compact Disc-Digital Audio), which is a disc used to digitally record and play back music of exceptionally high quality, or CD-I (Compact Disc-Interactive), which is a disc on which interactive multi-media applications can be stored and from which information can be read with the help of a CD-reader connected to a television. DVD can also be of interest. The type of disc chosen naturally reflects the function that is desired.

To be able to equip the card with other ways of storing information and other functions, one has to take advantage of the space available on the card. A magnetic field 5 and bar codes 6 can simply be placed on the card along one or more of the four straight edges, for example. Microprocessor units and transponder units 7 are also easy to place on the card.

The card can naturally be provided with illustrations and text on the card surface at the same time as information is found stored on or in the card.

The areas on the card that are not filled with information can be processed in any way chosen. It may be appropriate to design the card with a hole 8 to allow it to be attached to a carrying device in cases where the card is to function as an identity card and/or information transfer unit. Anything is possible as long as it does not affect the possibility of placing the card in a reading device.

The storage card should primarily function as a means of identification and an information writer, carrier and provider. The card functions as a means of identification, for example, during the use of databases, to gain access to company information, work projects, bank services and similar that can be accessed via computers, for example, via the Internet. The card can also be used as a means of identification to allow physical access to places of work, buildings, machinery and so on.

The card also works as an information writer, carrier and provider in a form just like a business card with printed text and stored images, text and sound for people, companies, organisations, clubs and similar. The information can be a type such as direct advertising but can also give instructions for performing tasks or pure information about different things. The card gives the user the possibility of regularly collecting information he or she needs for different purposes and for different reasons, for example via a computer system. It can be information about the book of the month in a book club, today's working tasks, the minutes of a meeting of an association, this month's medication, the latest songs of one's favourite musical artist, the annual report of the company, and so on.

The card can also function as a small notebook where it is possible to store things of interest, then take them home and do something with them. This can refer to information of the type named above or it could be a new customer address or something else.

Further areas of use can be for company gifts, product presentations, digital books, brochures, instruction manuals, tickets of different types, transmitters/receivers and naturally as credit cards, library cards, membership cards and much more. The size of the card and the amount of music or information that it can accommodate make it suitable for so-called release distributions to, for example, radio stations, for launching new artists, records, films or similar. The card can naturally also be given a function that more emphasises its entertainment value.

The above description should not be seen as limitations of the invention but only as guidelines for interpreting the invention according to the claims.

1. Storage card (1), for use together with a CD, DVD or similar device, with a rectangular shape that includes a circular segment (4) for storing information characterised in that the card has four corners that are rounded and that the rounding is equivalent to the circumference of the outer edge of a mini-CD.

2. Storage card according to claim 1 characterised in that the card has four linear edges.

3. Storage card according to claim 1 or 2 characterised in that the card includes at least one magnetic strip (5).

4. Storage card according to any of the claims 1 to 3 characterised in that the card includes at least one bar code (6).

5. Storage card according to any of the claims 1 to 4 characterised in that the card includes at least one transponder (7).

6. Storage card according to any of the foregoing claims characterised in that the card includes a CD-R-like function that allows both repeated writing and reading.
